(19) United States
(12) Patent Application Publication
(10) Pub. No.: US 2017/0298675 A1
(43) Pub. Date: Oct. 19, 2017

(54) POWERED STEP ASSEMBLY

(71) Applicant: Strattec Power Access LLC, Auburn Hills, MI (US)

(72) Inventors: Steven J. Dimig, Plymouth, WI (US); Zachary S. Husz, West Allis, WI (US); Greg Sproule, Auburn Hills, MI (US); Ken Easter, Auburn Hills, MI (US)

(21) Appl. No.: 15/475,770

(22) Filed: Mar. 31, 2017

Related U.S. Application Data
(60) Provisional application No. 62/323,300, filed on Apr. 15, 2016.

(51) Int. Cl. E05F 15/77; B60Q 1/24; B60Q 1/00; B60R 3/02; B62D 33/027; E05F 15/53; B62D 33/03

(52) U.S. Cl. CPC E05F 15/77; B60Q 1/0076; B60Q 1/24; B60R 3/02; E05F 15/53; B62D 33/03; E05Y 2400/85; E05Y 2900/546; B62D 33/0273

(57) ABSTRACT

A powered step assembly includes a drive mechanism and a step coupled to the drive mechanism. The step includes a first end and a second, opposite end. When the drive mechanism is activated, the step is both lowered linearly along an axis extending through the first end, and is also rotated about the axis, such that the second end is a free end configured to rotate away from a motor vehicle.

### CROSS-REFERENCE TO RELATED APPLICATIONS

This application claims priority to U.S. Provisional Application No. 62/323,300, filed Apr. 15, 2016, the entire contents of which are incorporated herein by reference.

### BACKGROUND OF THE INVENTION

The present invention relates to powered step assemblies and access systems, and more particularly to powered step assemblies for motor vehicles and access systems that open and close the powered step assemblies and/or other components on the motor vehicles.

Many motor vehicles, including pick-up trucks, have a rear bumper and a tailgate disposed above the rear bumper. The tailgate pivotally opens and closes, providing access to a bed in the back of the vehicle. However, the bed is typically located at a height that makes it difficult to step or climb into the bed.

### SUMMARY OF THE INVENTION

According to some constructions, the present invention provides a powered step assembly including a drive mechanism and a step coupled to the drive mechanism. The step includes a first end and a second, opposite end. When the drive mechanism is activated, the step is both lowered linearly along an axis extending through the first end, and is also rotated about the axis, such that the second end is a free end configured to rotate away from a motor vehicle.

According to other constructions, the present invention provides a motor vehicle including a rear bumper having a first end and a second, opposite end. The motor vehicle also includes a first tail light disposed above the first end, a second tail light disposed above the second end, and a powered step assembly disposed at least partially under or within the second end of the rear bumper. The powered step assembly includes a drive mechanism having a four-bar linkage, and a step coupled to the four-bar linkage. When the drive mechanism is activated, the step is lowered downwardly and away from the second end of the rear bumper.

Other features and aspects of the invention will become apparent by consideration of the following detailed description and accompanying drawings.

### BRIEF DESCRIPTION OF THE DRAWINGS

FIG. 1 is a perspective view of a motor vehicle having a powered step assembly according to one construction, the powered step assembly including a step disposed under a rear bumper in a stowed position.

FIG. 1A is a perspective view of the motor vehicle, showing two of the powered step assemblies under opposite ends of a rear bumper.

FIG. 2 is a perspective view of the motor vehicle, showing the step in a deployed position.

FIG. 3 is a perspective view of the motor vehicle, showing an operator using the powered step assembly to step into a bed of the motor vehicle.

FIGS. 4 and 5 are side and top views, respectively, of the motor vehicle, showing the step in the stowed position.

FIGS. 6 and 7 are side and top views, respectively, of the motor vehicle, showing the step in the deployed position.

FIG. 8 is a perspective view of the motor vehicle, showing a powered step assembly according to another construction, the powered step assembly having both a first step and a second step in a stowed position under the rear bumper.

FIG. 9 is a perspective view of the motor vehicle, showing the first step and the second step in a deployed position.

FIGS. 10 and 11 are side and top views, respectively, of the motor vehicle, showing the first step and the second step in the stowed position.

FIGS. 12 and 13 are side and top views, respectively, of the motor vehicle, showing the first step and the second step in the deployed position.

FIG. 14 is a rear view of the motor vehicle, showing clearance between a trailer hitch on the motor vehicle and the rear bumper.

FIGS. 15-18 are perspective views of the motor vehicle, showing the powered step assembly of FIG. 8 and an operator using the powered step assembly to step into the bed of the motor vehicle.

FIG. 19 is a perspective view of a modified rear bumper of the motor vehicle that includes a recess sized to receive the first and second steps of the powered step assembly of FIG. 8.

FIG. 20 is a perspective of the motor vehicle, showing the first and second steps moving out of the modified rear bumper and into the deployed position.

FIGS. 21 and 22 are side and top views, respectively, of the motor vehicle, showing the first and second steps in the stowed position within the modified rear bumper.

FIGS. 23 and 24 are side and top views, respectively, of the motor vehicle, showing the first and second steps in the deployed position outside of the modified rear bumper.

FIG. 25 is a perspective view of the motor vehicle, showing a directional lighting element that illuminates the first and second steps.

FIG. 25A is a perspective view of the motor vehicle, showing two of the direction lighting elements on opposite sides of the motor vehicle.

FIGS. 26-29 are perspective views of an access system according to one construction that is used to raise and lower a tailgate of the motor vehicle and to move the first and second steps of the powered step assembly of FIG. 8 between the stowed and deployed positions by pressing a button.

FIGS. 30-33 are perspective views of an access system according to another construction that is used to raise and lower the tailgate of the motor vehicle and to move the first and second steps of the powered step assembly of FIG. 8 between the stowed and deployed positions by touching a surface on a tail light of the motor vehicle.

FIGS. 34-36 are perspective views of an access system according to another construction that is used to raise and lower the tailgate of the motor vehicle without touching the motor vehicle.

FIG. 37 is a perspective view of the motor vehicle, showing a powered step assembly according to another construction, the powered step assembly having a step and a drive mechanism in the form of a four-bar linkage.

FIG. 38 is a perspective view of the motor vehicle, showing the step of the powered step assembly of FIG. 37 in a deployed position.

FIGS. 39 and 40 are side views of the motor vehicle, showing the step of the powered step assembly of FIG. 37 in a stowed and deployed position, respectively.

FIG. 41 is a top view of the motor vehicle, showing two of the powered step assemblies of FIG. 37, one on either side of the motor vehicle.

FIG. 42 is a side view of the motor vehicle, showing an operator using the powered step assembly of FIG. 37.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

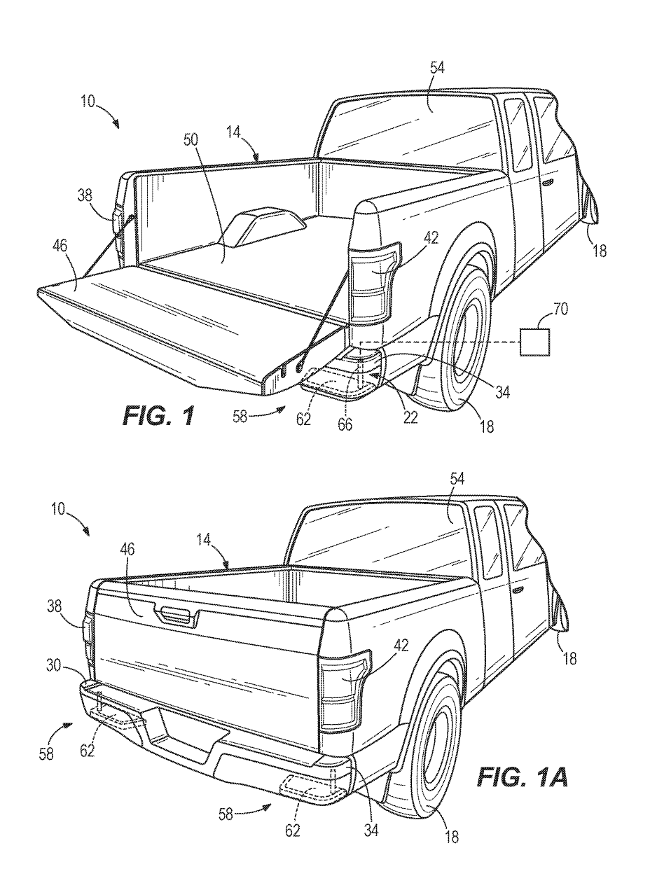

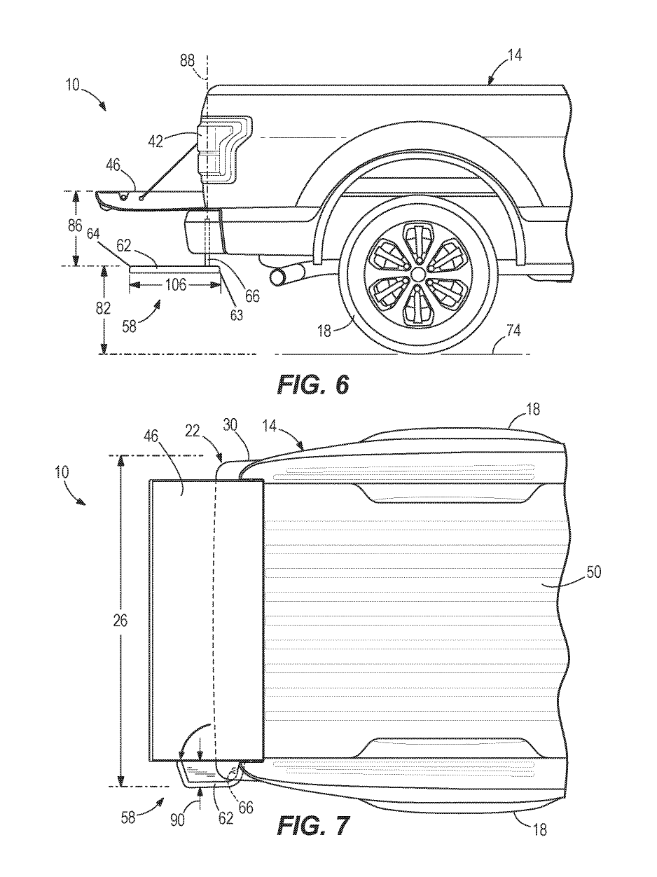

FIGS. 1-7 illustrate a motor vehicle 10 that includes a vehicle body 14 and tires 18 coupled to the vehicle body 14. The illustrated motor vehicle 10 is a pick-up truck, although other constructions include different types of motor vehicles, including semi-trucks, vans, etc. As illustrated in FIGS. 1-7, the vehicle body 14 includes a rear bumper 22 having a length 26 (FIGS. 5 and 7) and having a first end 30 and an opposite, second end 34. The vehicle body 14 includes a first tail light 38 disposed above the first end 30, and a second tail light 42 disposed above the second end 34. The vehicle body 14 further includes a tailgate 46 disposed between the first and second tail lights 38, 42. The tailgate 46 pivots between an opened position (FIG. 1) and a closed position. In the illustrated construction, the tailgate 46 pivots approximately 90 degrees between the opened and closed positions, although other constructions include different ranges. When in the opened position, the tailgate 46 extends over the rear bumper 22 and provides access to a bed 50. In some constructions, the bed 50 includes a liner. The bed 50 is a stowing area on the motor vehicle 10, and may be used for example to stow equipment or other materials. The vehicle body 14 further includes a cab 54 that is disposed ahead of the bed 50 and defines an area for a driver to sit and/or to operate the motor vehicle 10.

With continued reference to FIGS. 1-7, the motor vehicle 10 further includes a powered step assembly 58. In the illustrated construction, the powered step assembly 58 is disposed at least partially under the second end 34 of the rear bumper 22. In other constructions the powered step assembly 58 is disposed at least partially under the first end 30 of the rear bumper 22. In some constructions, the motor vehicle 10 includes more than one powered step assembly 58 (e.g., one powered step assembly 58 disposed at least partially under the first end 30 of the rear bumper 22 and a second powered step assembly 58 disposed at least partially under the second end 34 of the rear bumper 22, as illustrated in FIG. 1A). The powered step assembly 58 includes a step 62 coupled to a drive mechanism 66. The step 62 includes a first end 63 and a second opposite end 64 (FIG. 6). In the illustrated construction, the drive mechanism 66 is a helix drive shaft, although other constructions include different types of drive mechanisms (e.g., shafts, gears, etc.) The drive mechanism 66 is coupled to the rear bumper 22, although in other constructions the drive mechanism 66 is coupled to a location on the motor vehicle 10 other than the rear bumper 22 (e.g., to a location adjacent the rear bumper 22, and under the bed 50). The drive mechanism 66 is also coupled to a power source 70 (illustrated schematically in FIG. 1). In some constructions, the power source 70 is a motor disposed directly underneath the rear bumper 22, although other constructions include different types of power sources and/or locations for the power source 70 (e.g., under the bed 50). In some constructions, the power source 70 is integrally formed as part of the drive mechanism 66. In some constructions, the power source 70 includes or is otherwise coupled to a controller (e.g., processor) to receive a command signal or signals from an operator or person standing outside of the motor vehicle 10, such that the operator may control activation of the drive mechanism 66.

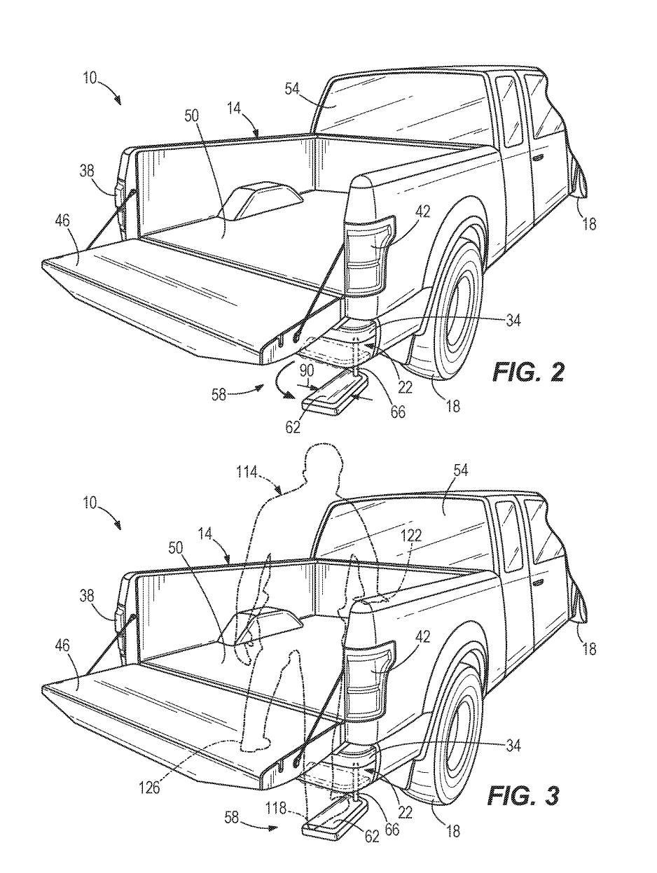

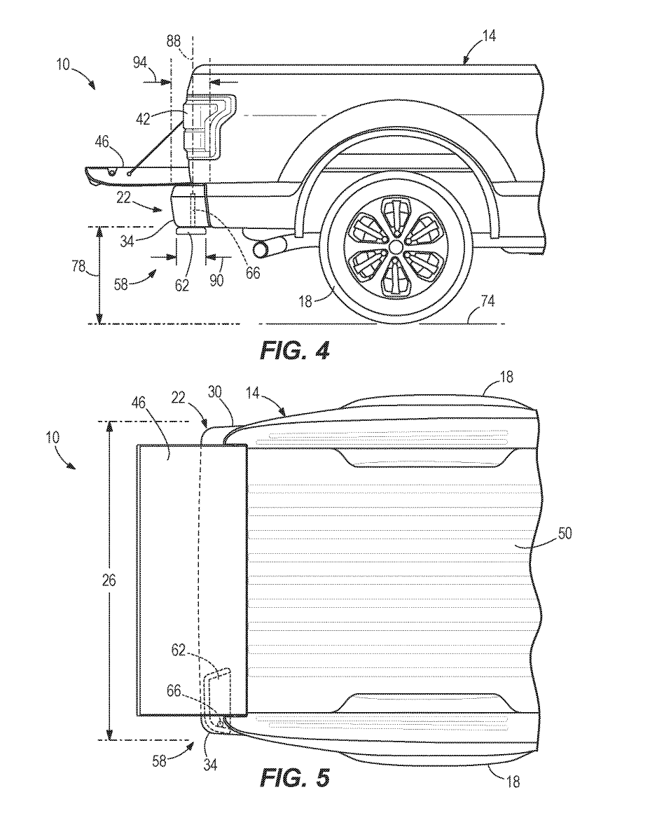

With continued reference to FIGS. 1-7, when the drive mechanism 66 is activated by the power source 70, the drive mechanism 66 moves the step 62 from a stowed position directly under the rear bumper 22 (FIGS. 1, 4, and 5) to a deployed position away from the rear bumper 22 (FIGS. 2, 3, 6, and 7). During this movement, the drive mechanism 66 moves the step 62 linearly away from the rear bumper 22 and toward a ground surface 74 (FIGS. 4 and 6), and also rotates the step 62 away from the rear bumper 22. In some constructions the step 62 is disposed within the rear bumper 22 in the stowed position, as opposed to being disposed below the rear bumper 22.

With reference to FIGS. 4 and 6, in the illustrated construction the drive mechanism 66 extends and moves the step 62 linearly from a first height 78 (FIG. 4) above the ground surface 74 to a second height 82 (FIG. 6) above the ground surface 74. In some constructions, the second height 82 is equal to or approximately equal to a third height 86 (FIG. 6) that extends between the step 62 and the top of the lowered tailgate 46. In some constructions both the second height 82 and the third height 86 are between 16 and 20 inches. In some constructions the second height 82 is 18 inches and the third height 86 is 17.5 inches. Other constructions include different values and ranges.

With reference to FIGS. 2, 3, and 7, in the illustrated construction the drive mechanism 66 rotates the step 62 by 90 degrees to the deployed position about an axis 88 (FIGS. 4 and 6) that extends through the drive mechanism 66 and is perpendicular to the ground surface 74. In other constructions the step 62 is rotated between 70 degrees and 110 degrees. Other constructions include different values and ranges, as well as different axes of rotation than that illustrated.

With reference to FIG. 6, the axis 88 extends through the first end 63 of the step 62, such that the second end 64 is a free end of the step 62 that is rotated out away from the motor vehicle 10.

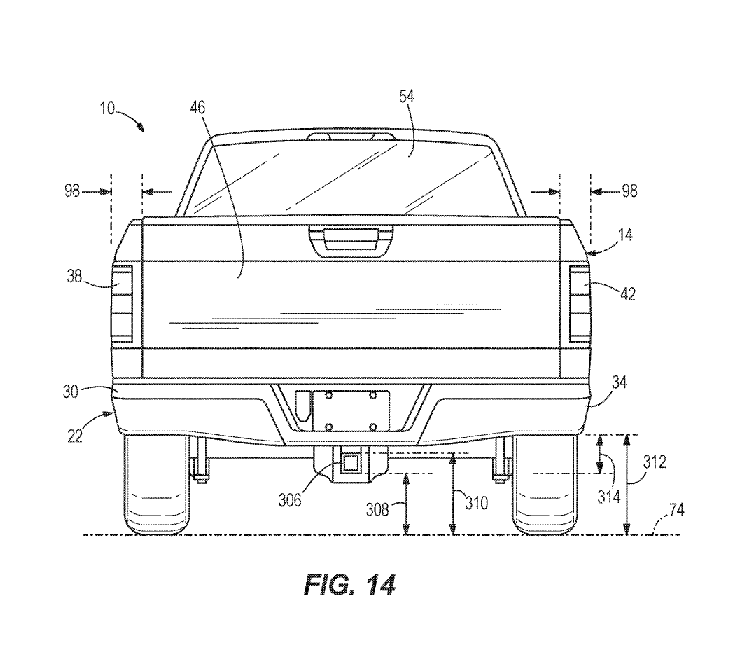

With reference to FIGS. 2, 4, and 7, the step 62 has a width 90. The width 90 of the step 62 is generally equivalent to or smaller than a corresponding width 94 (FIG. 4) of the rear bumper 22, such that the step 62 is partially or entirely concealed underneath the rear bumper 22 when in the stowed position. As illustrated in FIG. 14, the first and second tail lights 38, 42 also each have a width 98. In the illustrated construction, the width 98 of the first and second tail lights 42 is approximately equal to the width 90 of the step 62. With reference to FIG. 3, in some constructions the width 90 of the step 62 is equal to or larger than the width of an adult shoe or foot, such that the step 62 provides support for someone stepping up into the bed 50. Other constructions include different widths 90 than that illustrated.

With reference to FIG. 6, the step 62 also has a length 106 (along a direction between the first end 63 and the second end 64). The length 106 of the step 62 is smaller than the length 26 of the rear bumper 22. With reference to FIG. 3, in some constructions the length 106 is equal to or larger than the size of an adult shoe or foot, such that the step 62 provides support for someone stepping up into the bed 50. For example, in some constructions the length 106 is between 17 and 22 inches. In some constructions the length 106 is 19.5 inches. Other constructions include different values and ranges.

With reference to FIGS. 1-3, the powered step assembly 58 may be used when someone desires access to the bed 50. For example, to operate the powered step assembly 58, the drive mechanism 66 is activated. When the drive mechanism 66 is activated, the step 62 moves from the stowed position (FIG. 1) to the deployed position (FIG. 2). Once the step 62 is in the deployed position, an operator 114 (FIG. 3) then places his or her right foot 118 onto the step 62, and places his or her right hand 122 onto the vehicle body 14 (e.g., onto a corner of the bed 50) to brace himself or herself. The operator 114 then steps up and places his or her left foot 126 onto the tailgate 46 or onto the bed 50, and lifts his or her right foot 118 up off of the step 62. The step 62 thereby provides the operator 114 with a safe, efficient way to climb into the bed 50 of the motor vehicle 10. When the operator 114 desires to exit the bed 50, the operator 114 may simply repeat the same operation in reverse order. Once the operator 114 has safely stepped down off of the step 62, the operator 114 may then activate the drive mechanism 66 again to move the step 62 back to the stowed position.

FIGS. 8-18 illustrate an alternative powered step assembly 258 that may be used on the motor vehicle 10. In the illustrated construction, the powered step assembly 258 is disposed at least partially under the second end 34 of the rear bumper 22, similar to the powered step assembly 58. In other constructions the powered step assembly 258 is disposed at least partially under the first end 30 of the rear bumper 22. In some constructions, there is one powered step assembly 258 disposed at least partially under the first end 30 of the rear bumper 22 and a second powered step assembly 258 disposed at least partially under the second end 34 of the rear bumper 22.

The powered step assembly 258 includes more than one step. For example, in the illustrated construction the powered step assembly 258 includes a first step 262 and a second step 264, both coupled to a drive mechanism 266. The drive mechanism 266 is a helix drive mechanism, although other constructions include different types of drive mechanisms for moving the first and second steps 262, 264 (e.g., shafts, gears, etc.). In some constructions more than one drive mechanism 266 is used to move more than one step.

The drive mechanism 266 is coupled to the rear bumper 22, although in other constructions the drive mechanism 266 is coupled to a location on the motor vehicle 10 other than the rear bumper 22 (e.g., to a location adjacent the rear bumper 22, and under the bed 50). The drive mechanism 266 is also coupled to a power source 270 (illustrated schematically in FIG. 8). In some constructions, the power source 270 is a motor disposed directly underneath the rear bumper 22, although other constructions include different types of power sources and/or locations for the power source 270 (e.g., under the bed 50). In some constructions the power source 270 is integrally formed as part of the drive mechanism 266. In some constructions, the power source 270 includes or is otherwise coupled to a controller (e.g., processor) to receive a command signal or signals from an operator or person standing outside of the motor vehicle 10, such that the operator may control activation of the drive mechanism 266.

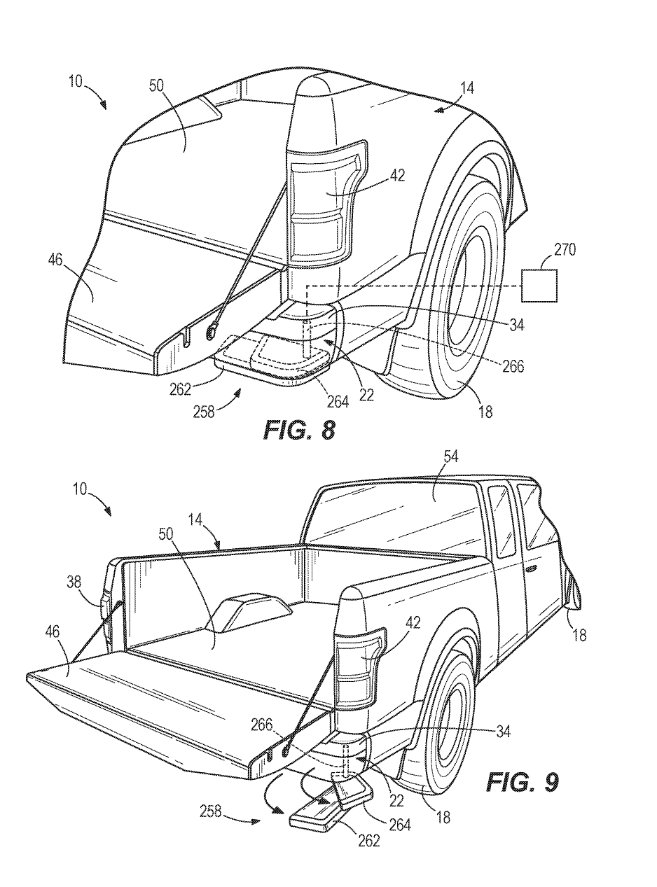

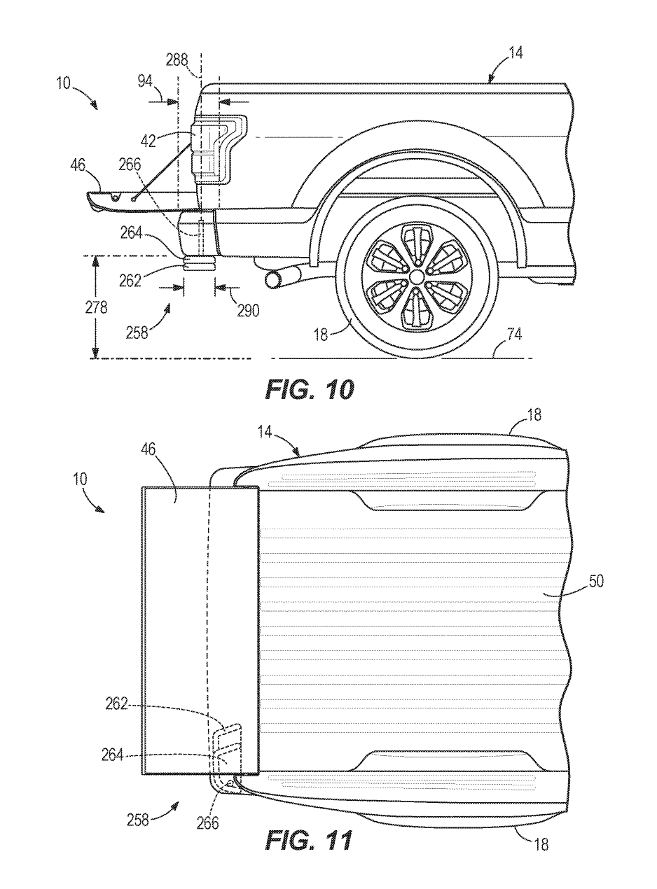

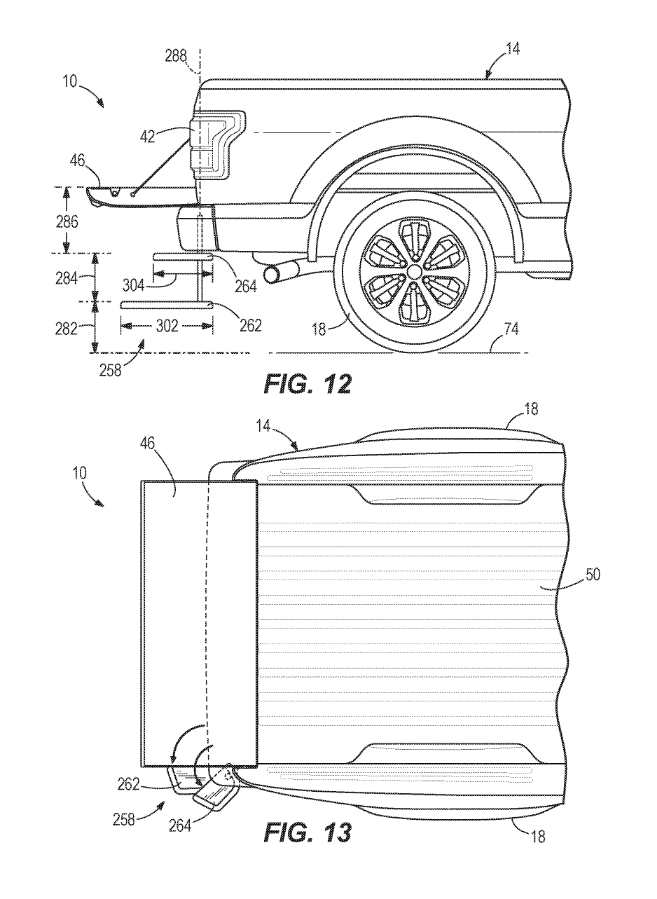

With continued reference to FIGS. 8-18, when the drive mechanism 266 is activated by the power source 270, the drive mechanism 266 moves the first step 262 and the second step 264 from a stowed position (FIGS. 8, 10, and 11) to a deployed position (FIGS. 9, 12, 13, and 15-18). During this movement, the drive mechanism 266 moves the first step 262 linearly away from directly under the rear bumper 22 and toward the ground surface 74 (FIGS. 10 and 12), and rotates both the first step 262 and the second step 264 away from the rear bumper 22.

With reference to FIGS. 10 and 12, in the illustrated construction the first step 262 is disposed directly underneath the second step 264 in the stowed position (FIG. 10). In some constructions the first step 262 physically abuts the second step 264 in the stowed position. When the drive mechanism 266 is activated, the drive mechanism 266 extends and moves the first step 262 away from the second step 264. The drive mechanism 266 extends the first step 262 linearly from a first height 278 above the ground surface 74 to a second height 282 above the ground surface 74, such that the second height 282 is equal to a third height 284 between the first step 262 and the second step 264, and such that each of the second and third heights 282, 284 are equal to or less than a fourth height 286 between the second step 264 and the top of the lowered tailgate 46 (FIG. 12). In some constructions, each of the second and third heights 282, 284 are between 9 and 12 inches. In some constructions, each of the second and third heights 282, 284 are 10.5 inches. In some constructions, the fourth height 286 is between 12 and 15 inches. In some constructions, the fourth height 286 is 13.5 inches. In some constructions, the second height 282 is different than the third height 284. In some constructions, the second height 282 and/or the third height 284 are greater than the fourth height 286. Other constructions include different, arrangements, as well as different values and ranges.

With reference to FIGS. 9 and 13, in the illustrated construction the drive mechanism 266 rotates the first step 262 by 90 degrees to the deployed position about an axis 288 (FIGS. 10 and 12) that extends through the drive mechanism 266 and is perpendicular to the ground surface 74. In other constructions the first step 262 is rotated between 70 degrees and 110 degrees. Other constructions include different values and ranges, as well as different axes of rotation than that illustrated.

With continued reference to FIGS. 9 and 13, the drive mechanism 266 rotates the second step 264 farther than the first step 262. For example, in the illustrated construction the drive mechanism 266 rotates the second step 264 by 130 degrees to the deployed position about the axis 288. In other constructions the second step 264 is rotated between 110 and 150 degrees. Other constructions include different value and ranges, as well as different axes of rotation than that illustrated. In some constructions the drive mechanism 266 instead rotates the first step 262 farther than the second step 264.

With reference to FIG. 10, the first step 262 and the second step 264 each have a width 290. The width 290 of the first step 262 and the second step 264 is generally equivalent to or smaller than the width 94 of the rear bumper 22, such that the first step 262 and the second step 264 are each partially or entirely concealed underneath the rear bumper 22 when in the stowed position. While the illustrated construction includes a first step 262 and a second step 264 each having the same width 290, in other constructions the first step 262 and the second step 264 have different widths.

As described above, the first and second tail lights 38, 42 also have a width 98. The width 98 of the first and second tail lights 38, 42 is approximately equal to the width 290 of the first step 262 and the second step 264. In some constructions the width 290 of the first step 262 and the second step 264 is equal to or larger than the width of an adult shoe or foot, such that the first and/or second steps 262, 264 provide support for someone stepping up into the bed 50. Other constructions include different widths 290 than that illustrated.

With continued reference to FIG. 12, the first step 262 has a length 302 and the second step 264 has a length 304. The length 302 of the first step 262 is larger than the length 304 of the second step 264, and is also smaller than the length 26 of the rear bumper 22. In some constructions the length 302 of the first step 262 and/or the length 304 of the second step 264 is equal to or larger than the size of an adult shoe or foot, such that the first and/or second steps 262, 264 provide support for someone stepping up into the bed 50. In some constructions, the length 302 of the first step 262 is between 17 and 22 inches. In some constructions the length 302 is 19.5 inches. In some constructions the length 304 of the second step 264 is between 10 and 15 inches. In some construction the length 304 of the second step 264 is 12.5 inches. Other constructions include different values and ranges.

With reference to FIG. 14, in some constructions the motor vehicle 10 includes a trailer hitch 306. A first distance 308 extends from the ground surface 74 to a bottom of the trailer hitch 306 and a second distance 310 extends from the ground surface 74 to a top of the trailer hitch 306. A third distance 312 extends from the ground surface 74 to the bottom of the rear bumper 22, and a fourth distance 314 extends from the bottom of the trailer hitch 306 to the bottom of the rear bumper 22. In some constructions the first distance 308 is between 16 and 20 inches. In some constructions the first distance 308 is 18 inches. In some constructions the second distance 310 is between 20 and 24 inches. In some constructions the second distance 310 is 22 inches. In some constructions the third distance 312 is between 22 and 26 inches. In some constructions the third distance 312 is 24 inches. The fourth distance 314 provides room and clearance for both the first and second steps 262, 264 to be stowed and/or to move and operate, such that the first and second steps 262, 264 do not extend below the trailer hitch 306 and potentially interfere with ground clearance. In some constructions the fourth distance 314 is between 4 and 8 inches. In some constructions the fourth distance 314 is 6 inches. Other constructions include different values and ranges for the first distance 308, second distance 310, third distance 312, and fourth distance 314.

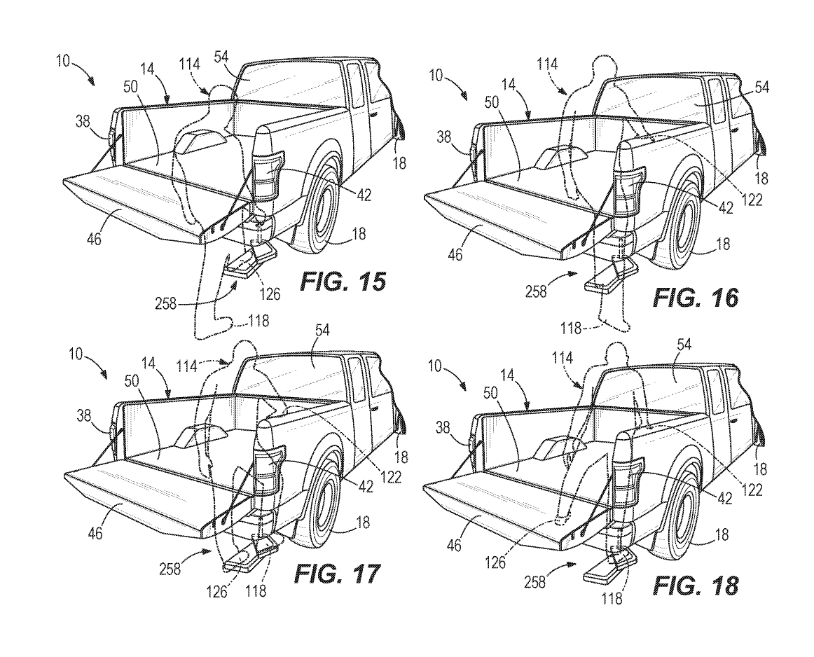

With reference to FIGS. 15-18, the powered step assembly 258 may be used when someone desires access to the bed 50. For example, to operate the powered step assembly 258, the drive mechanism 266 is activated. When the drive mechanism 266 is activated, the first step 262 and the second step 264 each move from the stowed position to the deployed position. Once the first and second steps 262, 264 are in the deployed positions, the operator 114 then places his or her left foot 126 onto the first step 262 (FIG. 15), and places his or her right hand 122 onto the vehicle body 14 (e.g., on a corner of the bed 50, as illustrated in FIG. 16) to brace himself or herself. The operator 114 then steps up and places his or her right foot 118 onto the second step 264 (FIG. 17), and lifts his or her left foot 126 up off of the first step 262 (FIG. 18) and onto the bed 50. The first and second steps 262, 264 thereby provide the operator 114 with a safe, efficient way to climb onto the bed 50 of the motor vehicle 10. When the operator 114 desires to exit the bed 50, the operator 114 may simply repeat the same operation in reverse order. Once the operator 114 has safely stepped down off of the first and second steps 262, 264, the operator 114 may then activate the drive mechanism 266 again to move the first and second steps 262, 264 back to the stowed position. While the illustrated construction includes a first step 262 and a second step 264, other constructions include more than two steps. For example, in some constructions the powered step assembly 258 may include three or more steps, with one or more of the steps rotating to a deployed position that facilitates the operator 114 in climbing onto the bed 50.

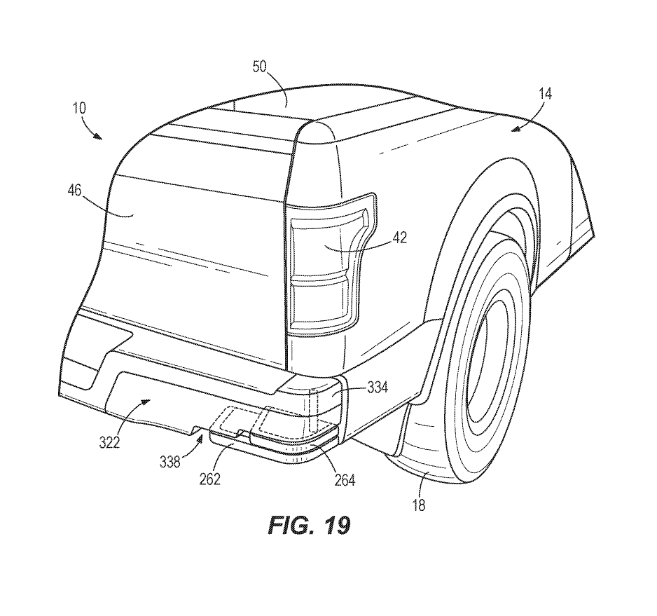

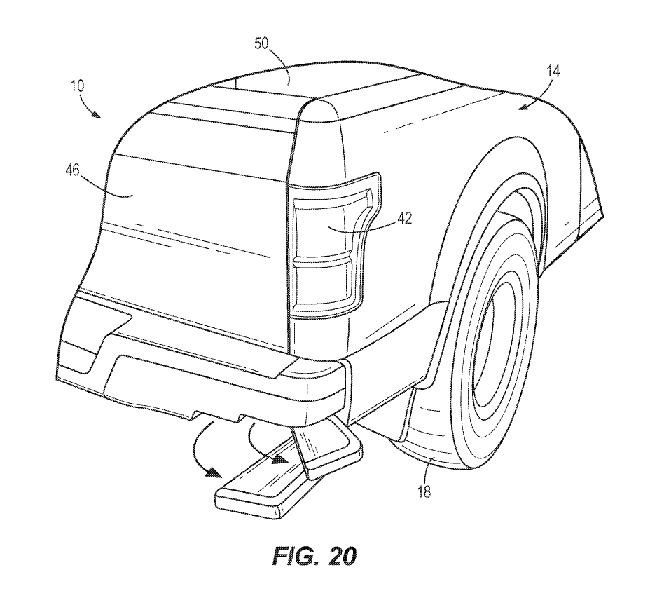

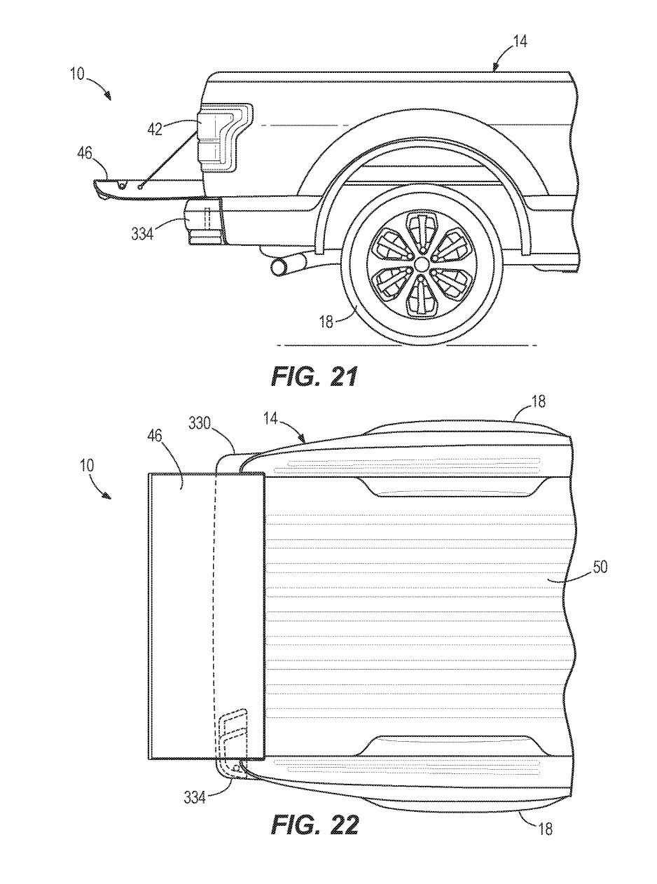

FIGS. 19-24 illustrate a modified rear bumper 322. The rear bumper 322 includes a first end 330 and a second, opposite end 334. A stepped recess 338 at the second end 334 is sized to receive the first and second steps 262, 264, such that the first and second steps 262, 264 are tucked up into and are otherwise integrated into the rear bumper 322 in the stowed position, as opposed to being disposed below rear bumper 22 as shown in FIGS. 8-18. In some constructions the rear bumper 322 includes a recess (e.g., stepped recess) at the first end 330, and the first and second steps 262, 264 are disposed within the recess at the first end 330. In some constructions the rear bumper 322 includes a recess at both the first end 330 and the second end 334, and power step assemblies 258 are located at both the first and second ends 330, 334. In some constructions the rear bumper 322 includes a lip or shield (not shown) that fills a portion of the recess 338 and at least partially protects the first step 262 and the second step 264, and the first and second steps 262, 264 both move linearly down and away from the rear bumper 322 and away from the lip or shield prior to either of the first and second steps 262, 264 rotating out and away from the rear bumper 322. Other constructions include different arrangements.

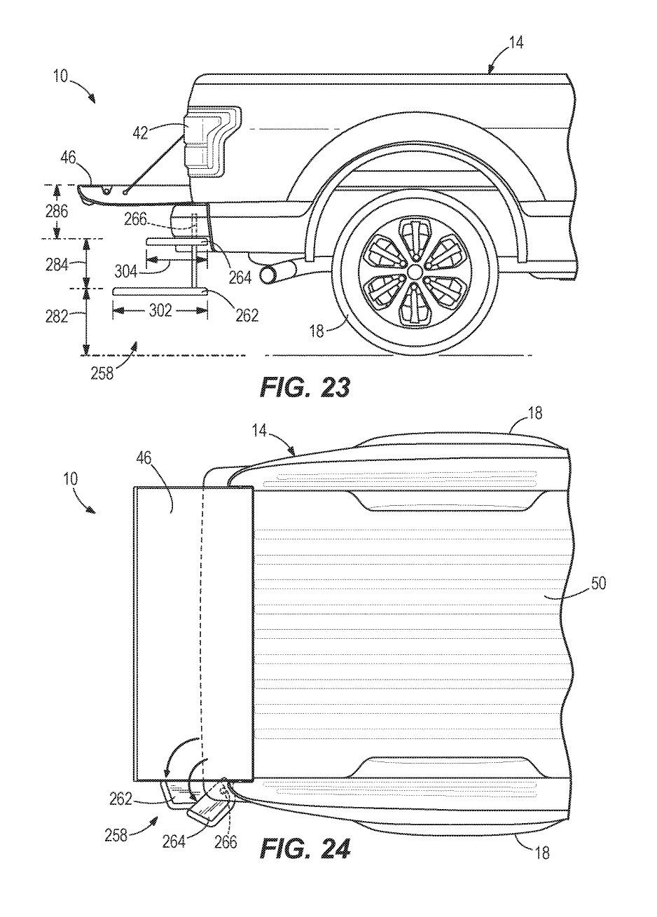

With reference to FIG. 23, because the first and second steps 262, 264 are integrated into the modified rear bumper 322, the second and third heights 282, 284 are slightly larger than those described above in FIGS. 8-18, and the fourth height 286 is slightly smaller than that described above in FIGS. 8-18. For example, in some constructions each of the second and third heights 282, 284 are between 11 and 13 inches. In some constructions, each of the second and third heights 282, 284 are each 12 inches. In some constructions, the fourth height 286 is between 10 and 13 inches. In some constructions, the fourth height 286 is 11.5 inches. Other constructions include different values and ranges.

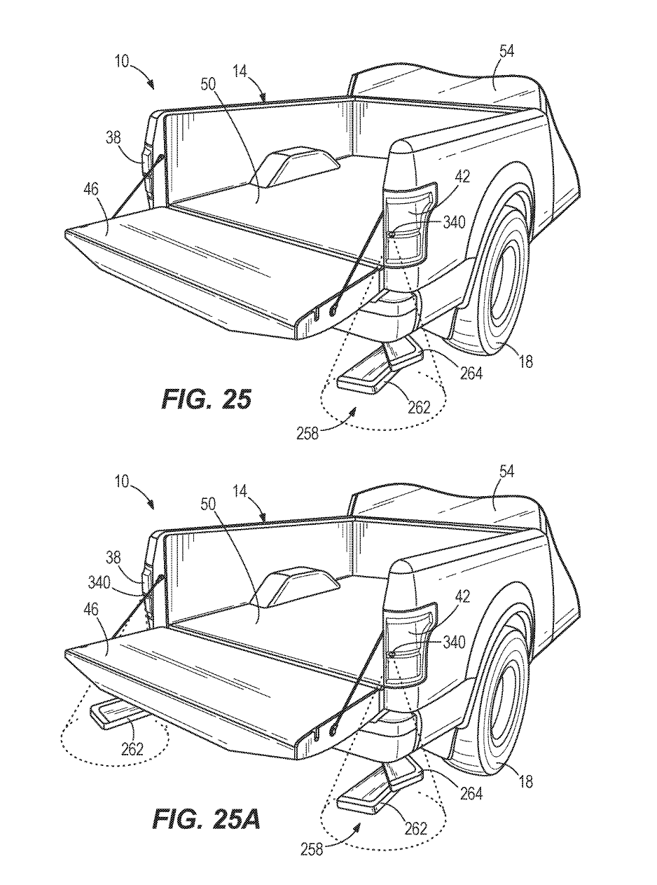

With reference to FIG. 25, in some constructions the motor vehicle 10 includes a directional lighting element 340. The directional lighting element 340 directs light onto the powered step assembly 258 (or 58), and specifically onto the steps 262, 264, 62 when the steps 262, 264, 62 are in the deployed position. In the illustrated construction, the directional lighting element 340 is disposed within the second tail light 42, although in other constructions the directional lighting element 340 is disposed in the first tail light 38, in both tail lights 38, 42 (see FIG. 25A), or at a location outside of both the first and second tail light 38, 42.

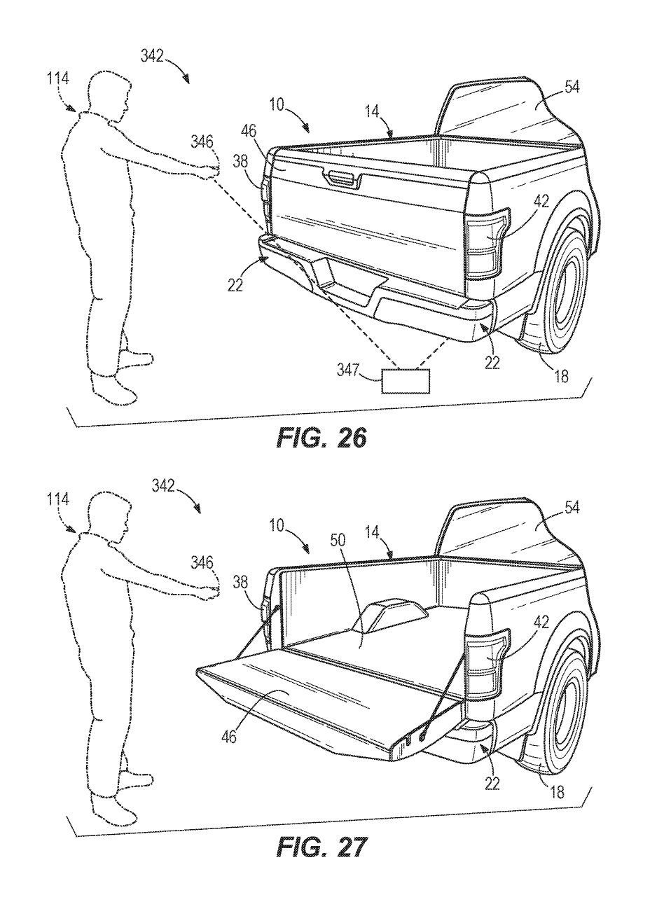

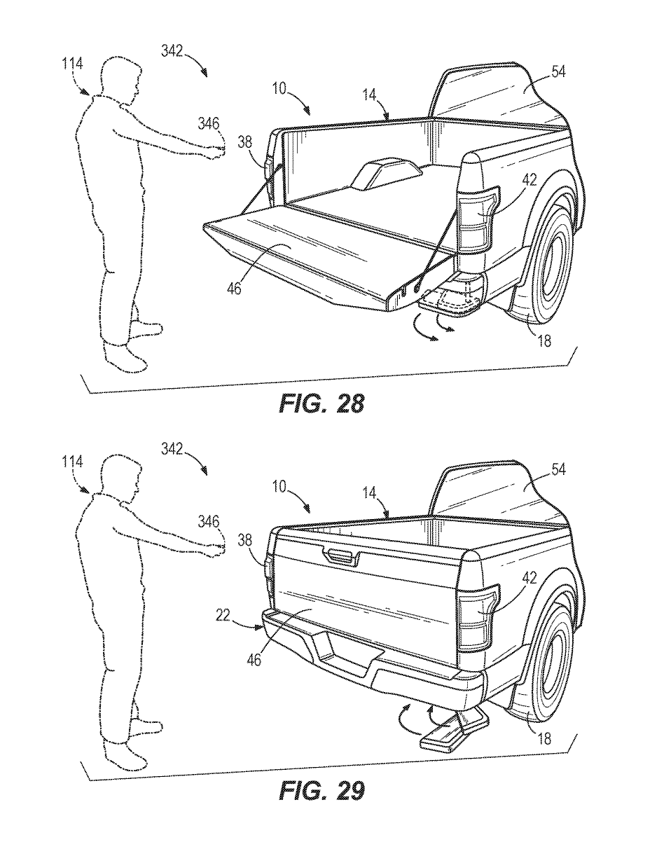

FIGS. 26-29 illustrate an access system 342 that is used to activate the tailgate 46 and the powered step assembly 258 (or 58). As illustrated in FIGS. 26-29, the operator 114 holds a key fob 346. When a button on the key fob 346 is pressed once, the tailgate 46 opens (FIG. 27). When the button on the key fob 346 is pressed a second time, the first and second steps 262, 264 (or 62) are moved to the deployed position. In some constructions, the button must be pressed twice within a limited time frame (e.g., 2 seconds) to cause the first and second steps 262, 264 (or 62) to move to the deployed position. When the button on the key fob 346 is pressed a third time (e.g., after the predetermined time period has passed), the tailgate 46 then closes and the first and second steps 262, 264 (or 62) return to the stowed position. In some constructions, if the tailgate 46 is already open, and the button is pressed once, the tailgate 46 closes. If the tailgate 46 is already open, and the button is pressed twice within a limited time frame (e.g., 2 seconds), then the tailgate 46 remains open and the first and second steps 262, 264 (or 62) are deployed. In some constructions, a motor or other drive mechanism (e.g., hydraulic arm) is disposed on the motor vehicle 10 that opens and closes the tailgate 46. In some constructions, a controller and/or sensor 347 (illustrated schematically in FIG. 26) are on or within the motor vehicle 10 (or elsewhere) and are used to receive signals from the key fob 346 and to interpret those signals and to direct the motor or other drive mechanism to open and close the tailgate 46, and/or to direct the drive mechanism 266 (or 66) to move the first and second steps 262, 264 (or 62) between the stowed and deployed positions. In some constructions the access system 342 activates only the tailgate 46, or only the powered step assembly 258 (or 58). Other constructions include different arrangements or patterns of pressing a button that control movement of the tailgate 46 and/or the powered step assembly 258 (or 58).

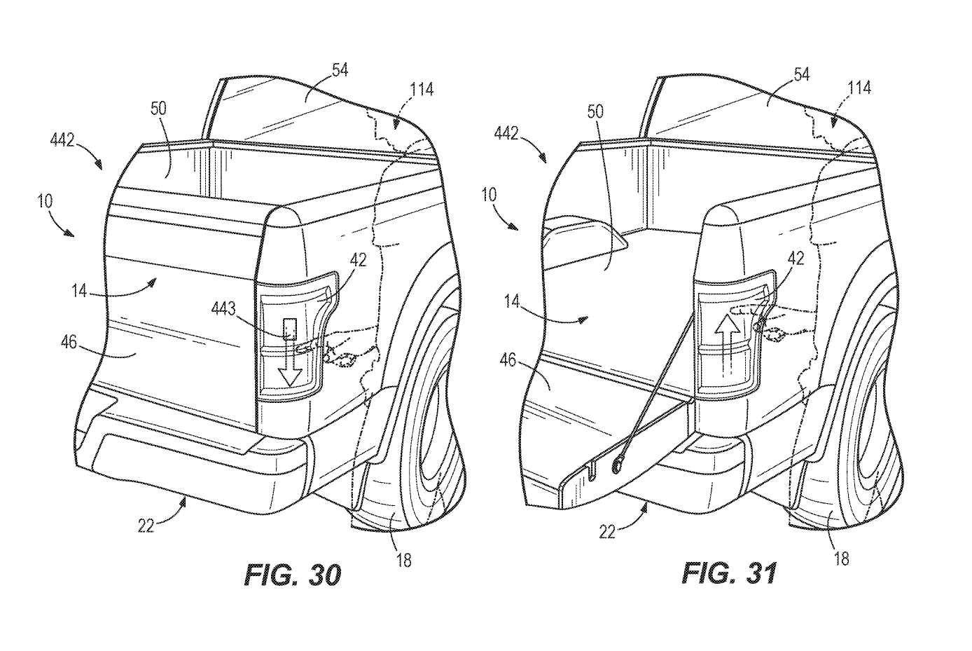

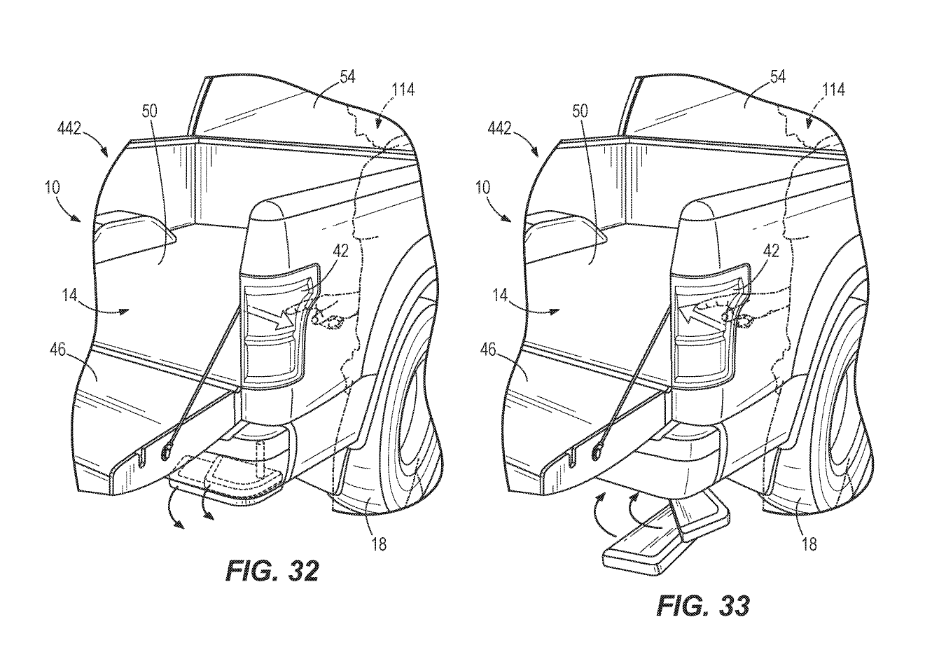

FIGS. 30-33 illustrate an access system 442 according to another construction that is used to activate the tailgate 46 and the powered step assembly 258 (or 58). As illustrated in FIGS. 30-33, when the operator 114 approaches the motor vehicle 10, a sensor 443 (illustrated schematically in FIG. 30) recognizes a passive fob (e.g., the key fob 346). To open the tailgate 46, the operator 114 then slides a finger down (FIG. 30) over a touch surface on the first or second tail light 38, 42, causing the tailgate 46 to power open. To close the tailgate 46, the operator 114 simply slides a finger back up (FIG. 31) along the touch surface on the first or second tail light 38, 42. To activate the powered step assembly 258 (or 58) and move the first and second steps 262, 264 (or 62) to the deployed position, the operator 114 slides a finger over the touch surface on the first or second tail light 38, 42 in a direction away from the bed 50 (FIG. 32). To activate the powered step assembly 258 (or 58) and move the first and second steps 262, 264 (or 62) to the stowed position, the operator 114 simply slides a finger back over the touch surface on the first or second tail light 38, 42 in a direction toward the bed 50 (FIG. 33). In some constructions the access system 442 activates only the tailgate 46, or only the powered step assembly 258 (or 58). Other constructions include different arrangements or patterns that control movement of the tailgate 46 and/or the powered step assembly 258 (or 58).

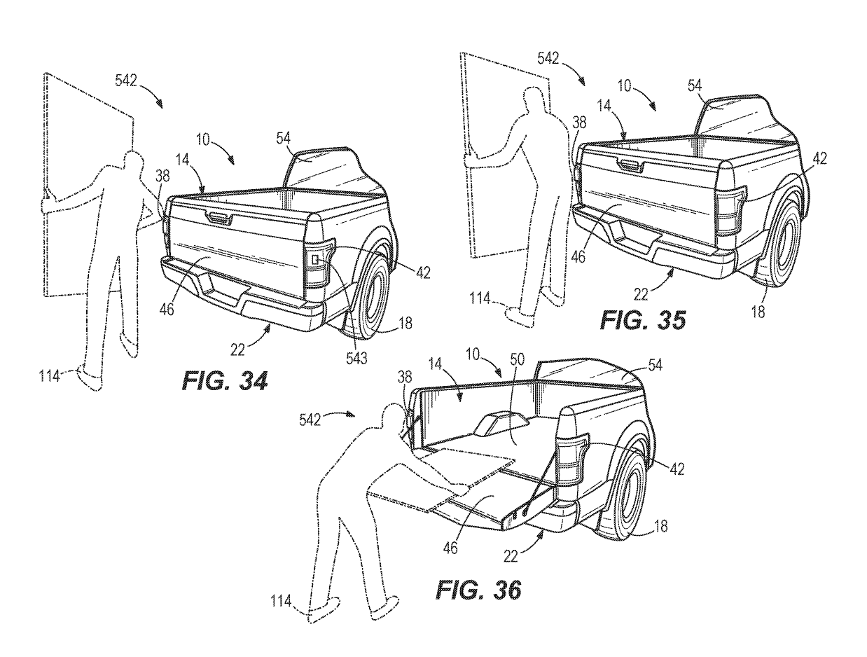

FIGS. 34-36 illustrate an access system 542 according to another construction that is used to activate the tailgate 46. While the illustrated construction only activates the tailgate 46, in some constructions the access system 542 also, or alternatively, activates a powered step assembly (e.g., the powered step assembly 258 or 58). The access system 542 relies on proximity detection. Specifically, when the operator 114 approaches the motor vehicle 10 with his or her hands full or occupied (as illustrated for example in FIGS. 34 and 35), the operator 114 simply motions in front of the first or second tail light 38, 42 (e.g., with an elbow or hip). A sensor 543 (illustrated schematically in FIG. 34) in the first and/or second tail light 38, 42 detects proximity (e.g., within a predefined proximity, such as within 1 ft., 2 ft., 3 ft., 4 ft., etc.) of the operator 114 or a device (e.g., the key fob 346, located in the operator's pocket), and based on the detection, opens the tailgate 46.

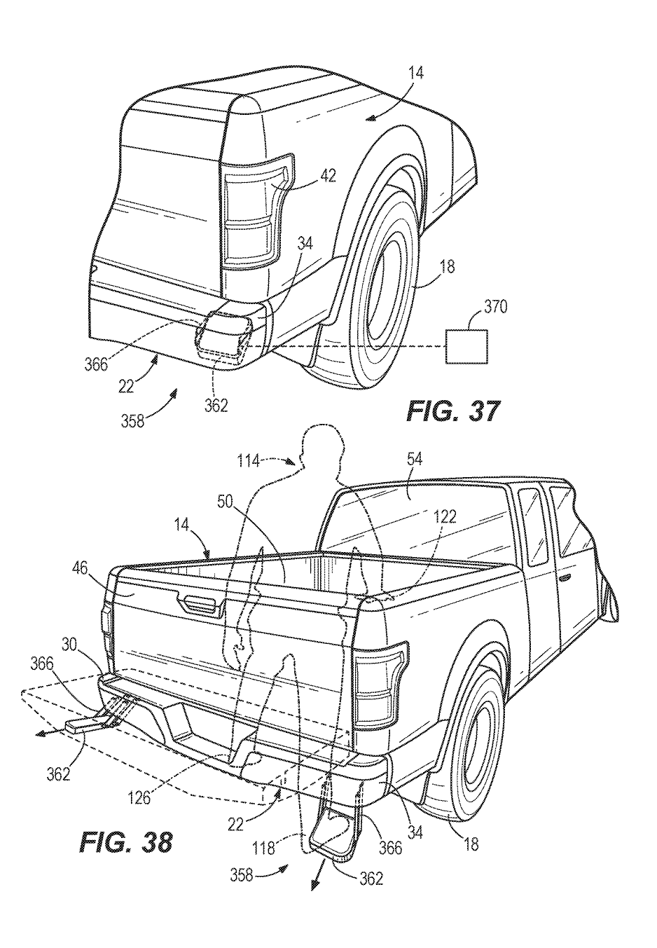

FIGS. 37-42 illustrate yet another powered step assembly 358 that may be used with the motor vehicle 10 to access the bed 50. The powered step assembly 358 includes a step 362 and a drive mechanism 366 in the form of a linkage (e.g., a four-bar linkage) that pivots the step 362 away from the bed 50 and the frame 14. In some constructions, the powered step assembly 358 may be used in combination with the access system 342, 442, or 542. For example, the step 362 and/or tailgate 46 may be opened and closed depending on use of the key fob 346, a touch surface on one of the tail lights 38, 42, proximity detection, etc.

The drive mechanism 366 is coupled to a power source 370 (illustrated schematically in FIG. 37). In some constructions, the power source 370 is a motor disposed directly underneath the rear bumper 22, although other constructions include different types of power sources and/or locations for the power source 370 (e.g., under the bed 50). In some constructions, the power source 370 is integrally formed as part of the drive mechanism 366. In some constructions, the power source 370 includes or is otherwise coupled to a controller (e.g., processor) to receive a command signal or signals from an operator or person standing outside of the motor vehicle 10, such that the operator may control activation of the drive mechanism 366.

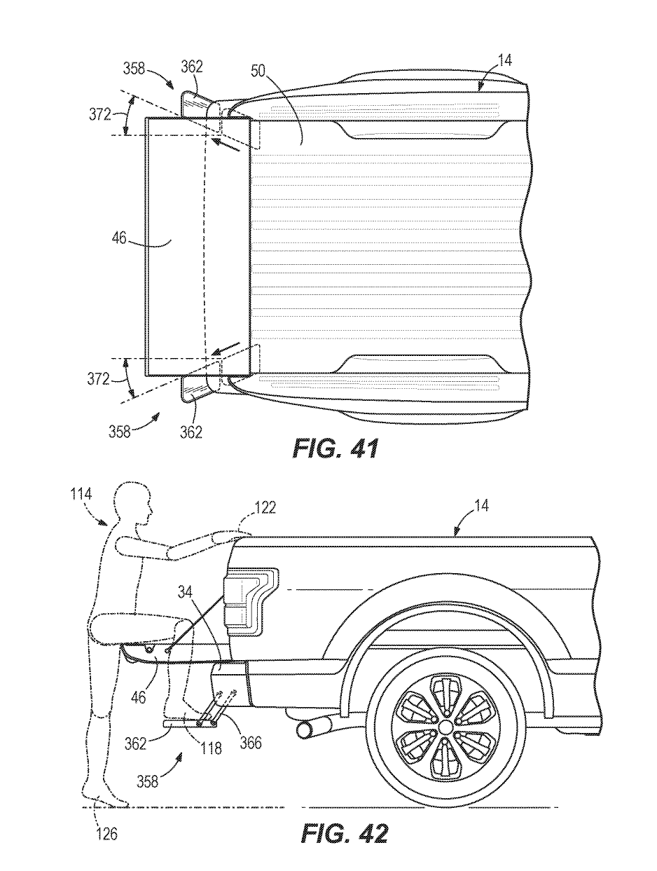

As illustrated in FIG. 38, in some constructions one powered step assembly 358 is disposed on each end 30, 34 of the rear bumper 22, although in other constructions only a single powered step assembly 358 is provided (e.g., on the second end 34). When in the stowed position, the step 362 is stowed underneath the rear bumper 22, and when in the deployed position the step 362 is spaced away from the rear bumper 22. In some constructions more than one step 362 is provided. For example, in some constructions two steps, similar to steps 262, 264 described above, are each moved with the drive mechanism 366. As illustrated in FIG. 41, the drive mechanism 366 moves the step 362 both downwardly and linearly away from the rear bumper 22. The step 362 is directed at an angle 372 relative to the rear bumper 22 (e.g., between approximately 30 to 60 degrees, although other constructions include different angles and ranges of angles), such that the step 362 projects laterally away from the frame 14 in the deployed position.

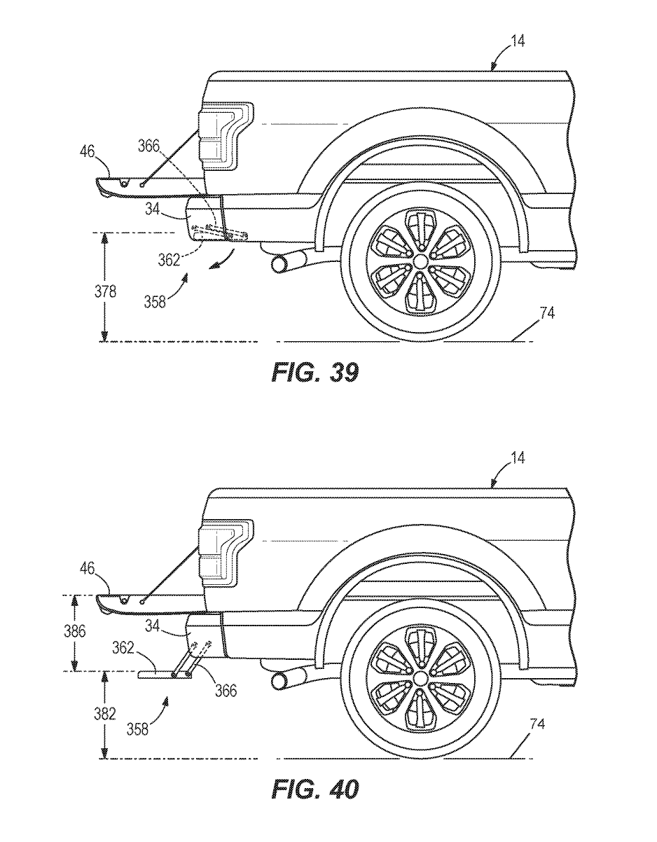

With reference to FIGS. 39 and 40, in the illustrated construction the drive mechanism 366 extends and moves the step 362 linearly from a first height 378 above the ground surface 74 to a second height 382 (FIG. 40) above the ground surface 74. In some constructions, the second height 382 is equal to or approximately equal to a third height 386 (FIG. 40) that extends between the step 362 and the top of the lowered tailgate 46. In some constructions both the second height 382 and the third height 386 are between 16 and 20 inches. In some constructions the second height 382 is 18 inches and the third height 386 is 17.5 inches. Other constructions include different values and ranges.

With reference to FIGS. 38 and 42, in some constructions the operator 114 places his or her right foot 118 onto the step 362 and then steps up and places his or her left foot 126 onto the tailgate 46 to access the bed 50, while using his or her right hand 122 to press against the frame 14. To step out of the bed the operator 114 repeats the process, but in a reverse order.

Although the invention has been described in detail with reference to certain preferred embodiments, variations and modifications exist within the scope and spirit of one or more independent aspects of the invention as described.

1. A powered step assembly comprising:
a drive mechanism; and
a step coupled to the drive mechanism, the step including a first end and a second, opposite end;
wherein when the drive mechanism is activated, the step is both lowered linearly along an axis extending through the first end, and is also rotated about the axis, such that the second end is a free end configured to rotate away from a motor vehicle.

2. The powered step assembly of claim 1, wherein the drive mechanism is a helix drive shaft, and wherein the axis extends through the helix drive shaft.

3. The powered step assembly of claim 1, wherein the drive mechanism is configured to rotate the step between 70 degrees and 110 degrees about the axis.

4. The powered step assembly of claim 1, wherein the step has a length of between 17 and 22 inches.

5. A motor vehicle comprising:
a rear bumper; and
the powered step assembly of claim 1, wherein the powered step assembly is disposed at least partially under or within the rear bumper.

6. The motor vehicle of claim 5, wherein the rear bumper includes a first end and a second, opposite end, wherein a first tail light is disposed above the first end, and a second tail light is disposed above the second end, and wherein the powered step assembly is disposed at least partially under or within the first or the second end of the rear bumper.

7. The motor vehicle of claim 6, wherein the powered step assembly is a first powered step assembly disposed at least partially under or within the first end of the rear bumper, and wherein the motor vehicle further includes a second powered step assembly disposed at least partially under or within the second end of the rear bumper.

8. The motor vehicle of claim 5, wherein the powered step assembly is configured to extend and move the step linearly from a first height above a ground surface to a second height above the ground surface, wherein the second height is equal to a third height that extends between the step and a top of a lowered tailgate of the motor vehicle when the step has been moved to the second height.

9. The motor vehicle of 8, wherein the second height and the third height are each between 16 inches and 20 inches.

10. The motor vehicle of claim 5, wherein the step has a first width and the rear bumper has a second width, wherein the first width is equal to or less than the second width.

11. The motor vehicle of claim 5, further comprising a directional lighting element that directs light onto the powered step assembly.

12. The motor vehicle of claim 5, further comprising an access system to control the powered step assembly, wherein the access system includes a key fob having a button.

13. The motor vehicle of claim 12, wherein when the button is pressed a first time, a tailgate of the motor vehicle is opened, and wherein when the button is pressed a second time, the step is lowered linearly along the axis and is also rotated about the axis.

14. The motor vehicle of claim 13, wherein the button is pressed a third time, the tailgate is moved to a closed position, and the step is moved to a stowed position.

15. The motor vehicle of claim 12, wherein if a tailgate of the motor vehicle is already open, and the key fob is pressed once, the tailgate closes, and if the tailgate is already open and the button is pressed twice within 2 seconds, the tailgate remains open and the step is lowered linearly along the axis and is also rotated about the axis.

16. The motor vehicle of claim 5, further comprising an access system to control the powered step assembly, wherein the access system includes a tail light having a touch surface, and wherein when an operator slides a finger along the touch surface, the step is lowered linearly along the axis and is also rotated about the axis.

17. The motor vehicle of claim 5, further comprising an access system to control the powered step assembly, wherein the access system includes a proximity sensor in the motor vehicle, wherein when an operator is within a predefined proximity to the motor vehicle, the step is lowered linearly along the axis and is also rotated about the axis.

18. The powered step assembly of claim 1, wherein the step is a first step, and wherein the powered step assembly includes a second step coupled to the drive mechanism.

19. The powered step assembly of claim 18, wherein when the drive mechanism is activated, the first step is lowered linearly along the axis away from the second step, and both the first step and the second step are rotated about the axis.

20. The powered step assembly of claim 19, wherein the second step is rotated about the axis farther than the first step.

21. The powered step assembly of claim 18, wherein the first step has a first length and the second step has a second length, and wherein the first length is larger than the second length.

22. A motor vehicle comprising:
a rear bumper; and
the powered step assembly of claim 18, wherein the powered step assembly is disposed at least partially under or within the rear bumper.

23. The motor vehicle of claim 22, wherein the rear bumper includes a stepped recess at one end of the rear bumper that is sized to receive the first and second steps, such that the first and second steps are tucked up into the rear bumper in a stowed position.

24. A motor vehicle comprising:
a rear bumper having a first end and a second, opposite end;
a first tail light disposed above the first end;
a second tail light disposed above the second end; and
a powered step assembly disposed at least partially under or within the first or the second end of the rear bumper, the powered step assembly including a drive mechanism having a four-bar linkage, and a step coupled to the four-bar linkage;
wherein when the drive mechanism is activated, the step is lowered downwardly and away from the second end of the rear bumper.

25. The motor vehicle of claim 24, wherein the powered step assembly is a first powered step assembly disposed at least partially under or within the first end of the rear bumper, and wherein the motor vehicle further includes a second powered step assembly disposed at least partially under or within the second end of the rear bumper.

26. The motor vehicle of claim 24, wherein when the drive mechanism is activated, the step is directed at an angle of between 30-60 degrees relative to the rear bumper, such that the step projects laterally away from a frame of the vehicle.

27. The motor vehicle of claim 24, wherein the powered step assembly is configured to extend and move the step linearly from a first height above a ground surface to a second height above the ground surface, wherein the second height is equal to a third height that extends between the step and a top of a lowered tailgate of the motor vehicle when the step has been moved to the second height.

28. The motor vehicle of 27, wherein the second height and the third height are each between 16 inches and 20 inches.

29. The motor vehicle of claim 24, further comprising an access system to control the powered step assembly, wherein the access system includes a key fob having a button.

30. The motor vehicle of claim 24, further comprising an access system to control the powered step assembly, wherein the access system includes a tail light having a touch surface, and wherein when an operator slides a finger along the touch surface, the step is lowered linearly along the axis and is also rotated about the axis.

31. The motor vehicle of claim 24, further comprising an access system to control the powered step assembly, wherein the access system includes a proximity sensor in the motor vehicle, wherein when an operator is within a predefined proximity to the motor vehicle, the step is lowered linearly along the axis and is also rotated about the axis.
